(19) United States
(12) Patent Application Publication
(10) Pub. No.: US 2004/0139995 A1
(43) Pub. Date: Jul. 22, 2004

(54) Rotatable or adjustable crutch

(76) Inventor: Erh Li Hsieh, Chong Ho City (TW)

Correspondence Address: Erh Li Hsieh, P.O. Box 10-69, Chong Ho, Taipei, 235, TW

(21) Appl. No.: 10/346,857

(22) Filed: Jan. 16, 2003

(51) Int. Cl. A61H 3/02

(52) U.S. Cl. 135/69

(57) ABSTRACT

A crutch includes an upper portion and a lower portion pivotally secured together with a shaft, at suitable angular position, and foldable to compact folding structure that is excellent for storing and transportation purposes. The lower and the upper portions of the crutch each may include a number of teeth engageable with each other, and a fastener to force the teeth toward and to engage with each other, and thus to adjustably secure the upper and the lower portions of the crutch together. The upper portion of the crutch includes a hand grip adjustably secured between two posts.

### BACKGROUND OF THE INVENTION

1. Field of the Invention

The present invention relates to a crutch, and more particularly to a crutch having a rotatable and/or an adjustable structure.

2. Description of the Prior Art

Various kinds of typical crutches have been developed and comprise an upper portion for engaging into armpit of user, and for supporting upper portions of users, and a lower portion adjustable up and down relative to the upper portion thereof, to adjust the crutch to different heights, according to the users need.

U.S. Pat. No. 5,788,608 to Wilkinson discloses one of the typical poles having an adjustable structure for allowing the poles to be adjusted to different heights. However, none of the typical crutches suggested to provide a crutch having a rotatable and foldable structure for allowing the crutch to be folded to a compact folding configuration.

The present invention has arisen to mitigate and/or obviate the afore-described disadvantages of the conventional crutches.

### SUMMARY OF THE INVENTION

The primary objective of the present invention is to provide a crutch having a rotatable and/or an adjustable structure for allowing the crutch to be folded to a compact folding configuration.

The other objective of the present invention is to provide a crutch having an easily adjustable hand grip for allowing the crutch to be adjusted to fit various users of various heights.

In accordance with one aspect of the invention, there is provided a crutch comprising an upper portion including a cushion provided on top thereof, and a lower portion pivotally coupled to the upper portion of the crutch with a shaft, and selectively secured to the upper portion the crutch at suitable or selected angular position. The lower portion and the upper portion of the crutch may also be folded to a compact folding or storing configuration that is excellent for storing and transportation purposes.

The lower portion and the upper portion of the crutch each includes a number of teeth facing toward each other and engageable with each other, and a fastener engaged through the upper portion and the lower portion of the crutch to force the teeth of the lower portion and the upper portion of the crutch toward each other and to engage with each other, to secure the upper portion and the lower portion of the crutch together.

The lower portion of the crutch includes at least one orifice formed therein, the upper portion of the crutch includes at least one screw hole formed therein, and the shaft includes a threaded extension engaged through the orifice of the lower portion of the crutch and threaded with the screw hole of the upper portion of the crutch, to force the teeth of the lower portion and the upper portion of the crutch toward each other when the threaded extension of the shaft is rotated relative to the upper portion and the lower portion of the crutch.

The upper portion of the crutch includes a pair of posts, and a hand grip disposed and adjustably secured between the posts. For example, two plates are secured to the posts respectively, and a fastener may adjustably secure the hand grip between the plates.

The plates each includes a groove formed therein, the hand grip includes a bore formed therein, the fastener is engaged through the grooves of the plate and the bore of the hand grip, and a lock nut is threaded with the fastener to secure the hand grip to the plates.

The hand grip includes two ends each having a channel formed therein, to slidably receive the plates respectively, and to guide the hand grip to move relative to the plates and the posts. Two blocks may further be provided and threaded with the fastener which may force the blocks to engage with the plates respectively.

The plates each includes a number of teeth provided thereon, the blocks each includes a number of teeth provided thereon and engaged with the teeth of the plates, to secure the blocks to the plates respectively. The posts each includes a notch formed therein, to receive the blocks therein respectively.

The lower portion of the crutch includes a tube, a leg adjustably secured to the tube, a duct secured between the tube and the leg. The duct includes a portion secured to the tube, and an inner thread formed therein, the leg includes an outer thread to thread with the inner thread of the duct. The duct includes a quick release clamp to releasably secure the leg to the duct.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a crutch in accordance with the present invention;

FIG. 2 is a partial exploded view of the crutch;

FIG. 3 is a further partial exploded view of the crutch;

FIG. 4 is a partial plan schematic view of the crutch;

FIG. 5 is a partial plan schematic view similar to FIG. 4, illustrating the operation or rotatable adjustment of the crutch;

FIG. 6 is a still further partial exploded view of the crutch;

FIG. 7 is another partial plan schematic view of the crutch;

FIG. 8 is a partial plan schematic view similar to FIG. 7, illustrating adjustment of the a handgrip;

FIG. 9 is a still further partial exploded view of the crutch;

FIG. 10 is a further partial plan schematic view of the crutch;

FIG. 11 is a partial plan schematic view similar to FIG. 10, illustrating adjustment of a foot pole; and

FIG. 12 is a still further partial plan schematic view illustrating the folding operation of the crutch.

### DETAILED DESCRIPTION OF THE PREFERRED EMBODIMENT

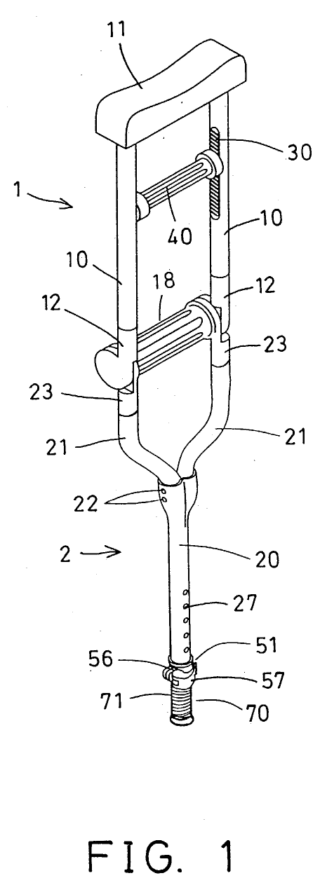

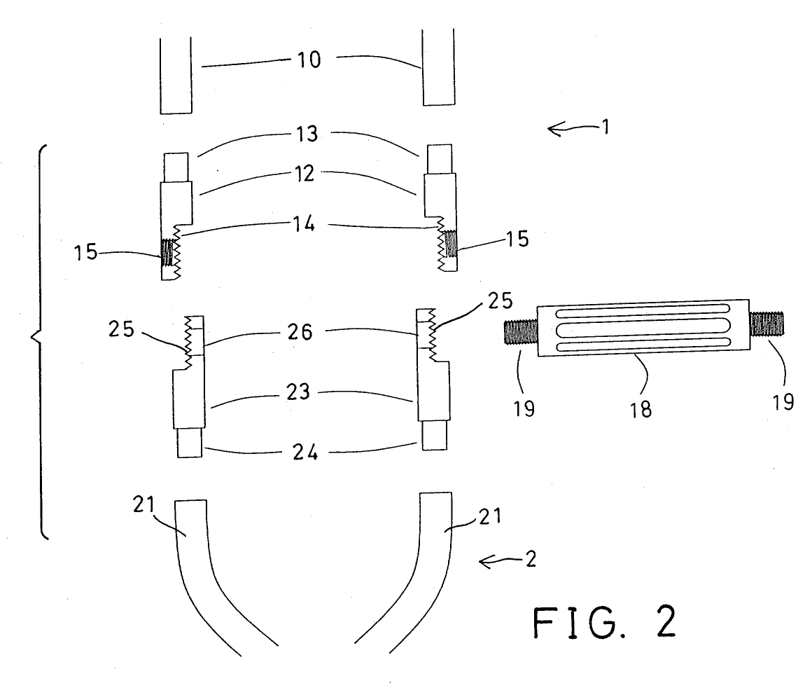

Referring to the drawings, and initially to FIGS. 1-5, a crutch in accordance with the present invention comprises an upper portion 1 and a lower portion 2 to be rotatably or adjustably secured together with a shaft 18, for allowing the upper portion 1 and the lower portion 2 to be rotated to an open or working position as shown in FIG. 1, and a folded position as shown in FIG. 12.

The upper portion 1 of the crutch includes two posts 10, a pad or cushion 11 disposed on top of the posts 10, to engage into an armpit of a user, and for supporting the upper portion of the user. The posts 10 each includes a bar 12 having an upper stud 13 engaged or secured into the bottom of the respective post 10 with such as force-fitted engagements, fasteners, or by welding processes. The bars 12 each includes a screw hole 15 formed therein, and a number of teeth 14 formed or provided around the screw hole 15 thereof.

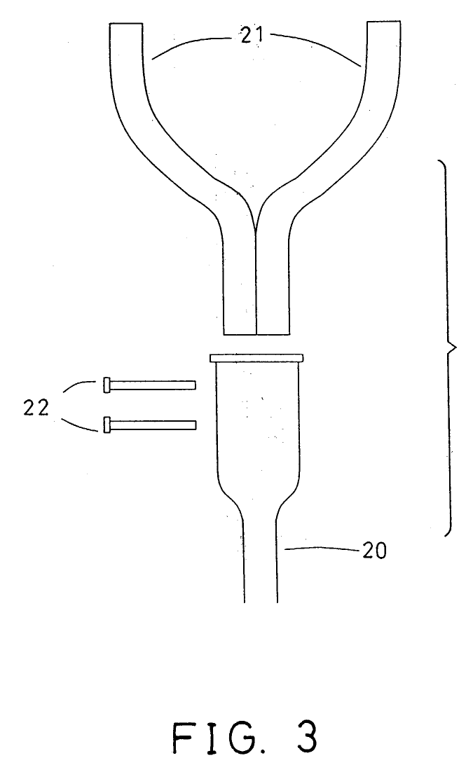

The lower portion 2 of the crutch includes a tube 20, two cranks or arms 21 secured on top of the tube 20 with fasteners 22 (FIGS. 1, 3), force-fitted engagements, and/or by welding processes. The arms 21 each includes a rod 23 having a lower stud 24 engaged or secured into the upper portion of the respective arms 21 with such as force-fitted engagements, fasteners, or by welding processes. The rods 23 each includes an orifice 26 formed therein, and a number of teeth 25 formed or provided around the orifice 26 thereof.

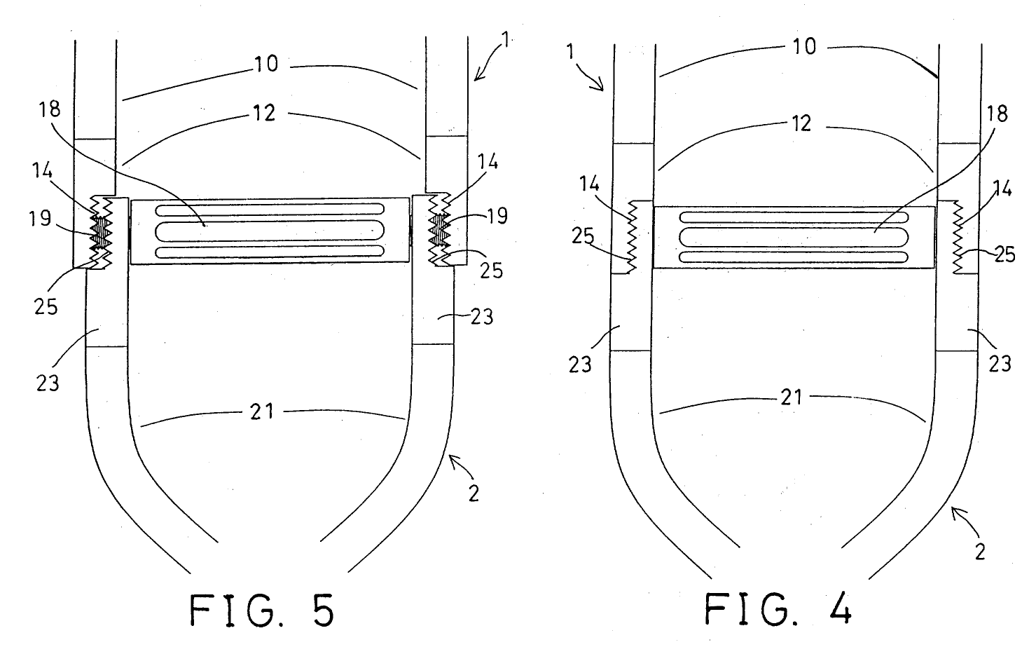

The shaft 18 includes two threaded extensions 19 extended from two ends thereof and engaged through the orifices 26 of the rods 23 respectively, and threaded with the screw holes 15 of the bars 12 respectively, for rotatably securing the upper portion 1 and the lower portion 2 of the crutch together. The teeth 25 of the rods 23 of the lower portion 2 are engageable with the teeth 14 of the bars 12 of the upper portion 1 of the crutch (FIGS. 4, 5), for allowing the upper portion 1 and the lower portion 2 of the crutch to be secured to each other at any suitable or selected angular position.

In operation, as shown in FIGS. 4, 5, when the threaded extensions 19 of the shaft 18 are rotated relative to the rods 23 or bars 12, the threaded engagement between the threaded extensions 19 of the shaft 18 and the screw holes 15 of the bars 12 may force the teeth 25 of the rods 23 of the lower portion 2 to be moved toward and to engage with the teeth 14 of the bars 12 of the upper portion 1 of the crutch (FIG. 4), or to be moved away from each and to be disengaged from the teeth 14 of the bars 12 of the upper portion 1 of the crutch (FIG. 5), for allowing the upper portion 1 of the crutch to be rotated relative to the lower portion 2 of the crutch when the teeth 25 of the rods 23 and the teeth 14 of the bars 12 are disengaged from each other, and thus for allowing the upper portion 1 and the lower portion 2 of the crutch to be adjustably secured to each other at any suitable angular position.

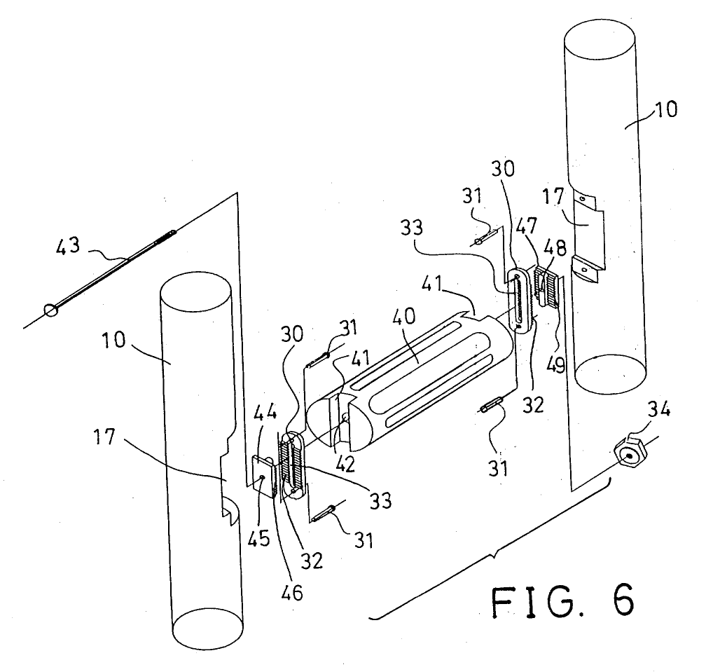

As shown in FIGS. 6-8, and again to FIG. 1, the posts 10 each includes a notch 17 formed therein, such as formed in the inner portion thereof. Two plates 30 are secured to the posts 10, with such as fasteners 31, to partially block the respective notches 17 of the posts 10, and each includes a number of teeth 32 formed thereon and facing toward the posts 10, or received in the notches 17 of the posts 10, and each includes a groove 33 formed therein.

A hand grip 40 includes two ends each having a channel 41 formed therein for slidably receiving the respective plates 30, and for guiding the hand grip 40 to move up and down relative to the posts 10 and the plates 30. The hand grip 40 includes a bore 42 formed therethrough, for receiving a fastener 43 therein. The fastener 43 has two ends slidably received in the grooves 33 of the plates 30 respectively, for allowing the fastener 43 and the hand grip 40 to move or to adjust up and down relative to the plates 30 and thus the posts 10.

A block 44 is received in the notch 17 of one of the posts 10, and includes a bore 45 formed therein for slidably receiving one end of the fastener 43, and includes one or more teeth 46 formed or provided on one side thereof for engaging with the teeth 32 of one of the plates 30, and thus for selectively or adjustably securing the block 44 and the hand grip 40 to the plate 30 and the post 10.

Another block 47 is received in the notch 17 of the other post 10, and includes a bore 48 formed therein for slidably receiving the fastener 43, and also includes one or more teeth 49 formed or provided on one side thereof for engaging with the teeth 32 of the other plate 30, and thus for selectively or adjustably securing the block 47 and the hand grip 40 to the other plate 30 and the post 10.

A lock nut 34 is threaded with one end of the fastener 43, to force the blocks 44, 47 toward or to engage with the plates 30, and to force the teeth 46, 49 of the blocks 44, 47 to engage with the teeth 32 of the plates 30, before the blocks 44, 47 and the hand grip 40 have been moved or adjusted relative to the plates 30 and the posts 10 to the required position, and thus for allowing the hand grip 40 to be adjusted up and down along or relative to the posts 10.

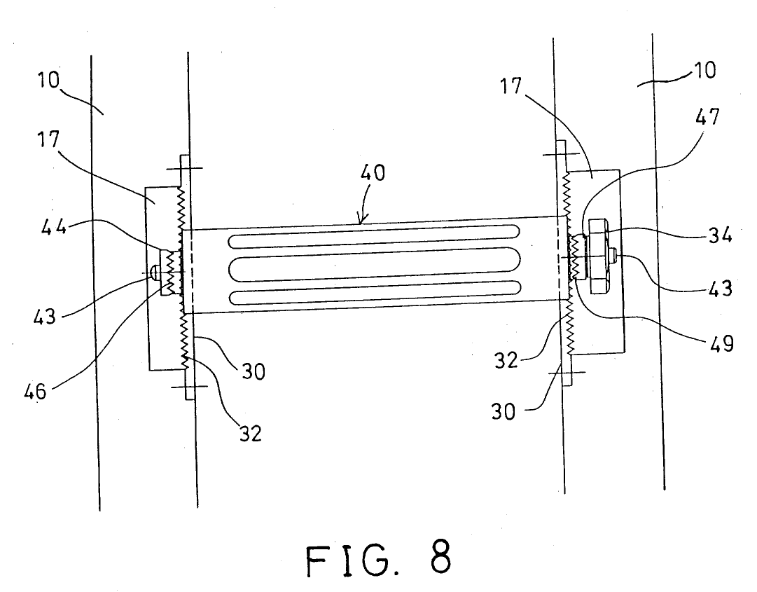

In operation, as shown in FIG. 8, the teeth 46, 49 of the blocks 44, 47 may be disengaged from the teeth 32 of the plates 30, by unthreading the lock nut 34 relative to the fastener 43, for allowing the blocks 44, 47 to be moved or adjusted relative to the plates 30 and the posts 10 to the required position, and thus for allowing the hand grip 40 to be adjusted up and down relative to the posts 10. The lock nut 34 may be reached and rotated via the respective notches 17 of the posts 10.

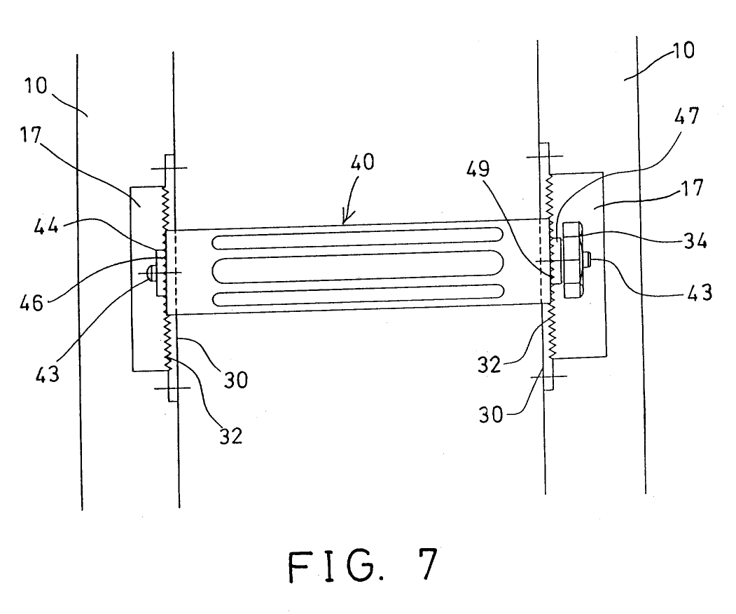

As shown in FIG. 7, when the lock nut 34 is threaded relative to the fastener 43 to force the blocks 44, 47 toward or to engage with the plates 30, and thus to force the teeth 46, 49 of the blocks 44, 47 to engage with the teeth 32 of the plates 30, the blocks 44, 47 and the hand grip 40 may then be secured to the plates 30 and the posts 10 at the required or selected position, without disengaging the hand grip 40 from the posts 10.

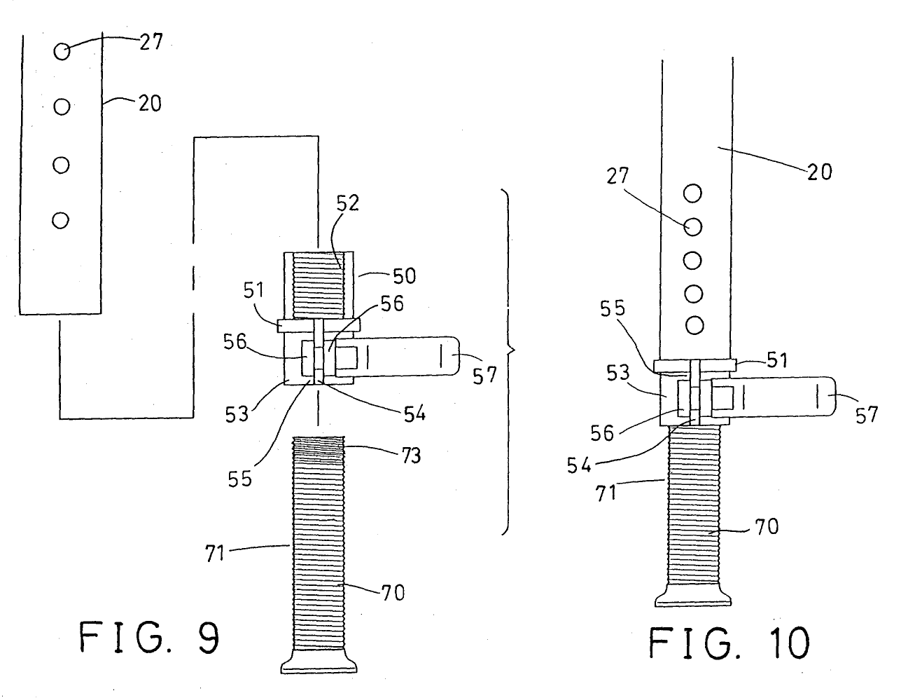

As shown in FIGS. 9-11, the tube 20 includes one or more apertures 27 formed in the lower portion thereof. A duct 50 has an upper portion engaged and secured in the bottom portion of the tube 20, and includes a peripheral stop 51 extended laterally or radially out from the middle portion thereof for engaging with the tube 20, and for positioning or securing the duct 50 to the tube 20. The duct 50 includes an inner thread 52 formed therein.

A leg 70 includes an outer thread 71 for threading with the inner thread 52 of the duct 50, and thus for adjusting the leg 70 relative to the duct 50 and the tube 20. The leg 70 includes a marked area or portion or element 73 provided on top thereof, and to be seen through either of the apertures 27 of the tube 20, for allowing the user to see and to check and to know the relative position between the tube 20 and the leg 70.

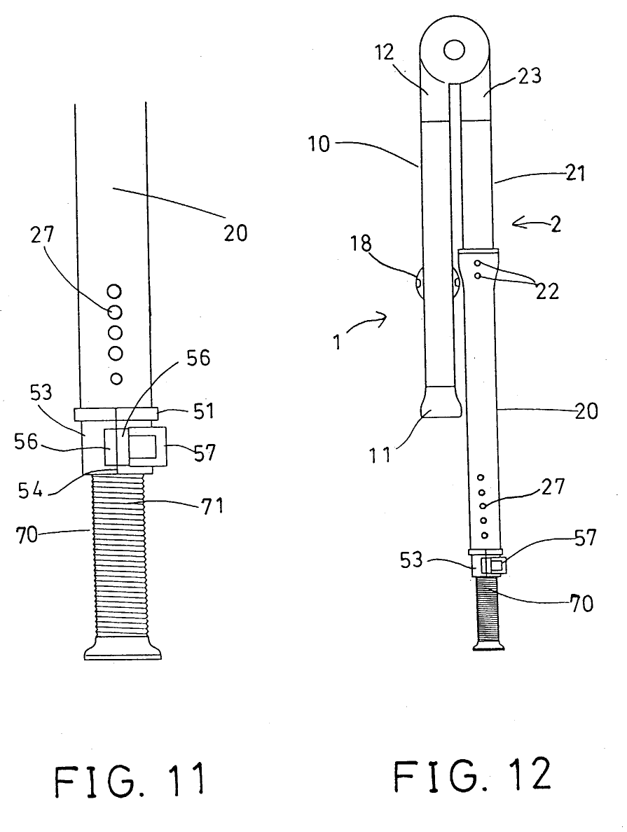

The duct 50 includes a lower portion 53 having a slot 54 formed therein to form or define a pair of opposite flanges 55 each of which includes an ear 56 extended therefrom. A quick release clamp 57 is engaged with the ears 56 of the duct 54, for forcing the flanges 55 of the duct 50 toward each other (FIG. 11), in order to enclose the slot 54 of the duct 50, and so as to clamp and to position or to lock the duct 50 and the leg 70 together.

In operation, as shown in FIG. 10, when the quick release clamp 57 is released to disengage the ears 56 of the duct 54 from each other, the leg 70 may be rotated and threaded with the inner thread 52 of the duct 50, in order to adjust the leg 70 relative to the tube 20 and the duct 50. When it is required to lock the leg 70 to the duct 50 and the tube 20, it is only required to rotate or to operate the quick release clamp 57 to force the flanges 55 of the duct 50 toward each other and to clamp the leg 70 in the duct 50.

The adjustment of the leg 70 relative to the tube 20 allows the crutch to fit various users of different heights. In addition, the hand grip 40 may also be easily adjusted relative to the posts 10 without disengaging or removing the hand grip 40 from the posts 10. Furthermore, the upper portion 1 of the crutch may be rotated and adjusted relative to the lower portion 2 thereof, to any suitable or selected angular position, for allowing the users to use the crutch at any suitable conditions.

Accordingly, the crutch in accordance with the present invention includes a rotatable and/or adjustable structure for allowing the crutch to be folded to a compact folding configuration, and includes an easily adjustable hand grip for allowing the crutch to be adjusted to fit various users of various heights.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A crutch comprising:
an upper portion including a cushion provided on top thereof,
a lower portion pivotally coupled to said upper portion of said crutch with a shaft, and
means for selectively securing said upper portion and said lower portion of said crutch together.

2. The crutch as claimed in claim 1, wherein said selectively securing means includes a plurality of teeth provided on said lower portion of said crutch, a plurality of teeth provided on said upper portion of said crutch, and means for forcing said teeth of said lower portion and said upper portion of said crutch toward each other and to engage with each other, to secure said upper portion and said lower portion of said crutch together.

3. The crutch as claimed in claim 2, wherein said lower portion of said crutch includes at least one orifice formed therein, said upper portion of said crutch includes at least one screw hole formed therein, and said forcing means includes a threaded extension extended from said shaft and engaged through said at least one orifice of said lower portion of said crutch and threaded with said at least one screw hole of said upper portion of said crutch, to force said teeth of said lower portion and said upper portion of said crutch toward each other when said threaded extension of said shaft is rotated relative to said upper portion and said lower portion of said crutch.

4. The crutch as claimed in claim 1, wherein said upper portion of said crutch includes a pair of posts, and a hand grip disposed and secured between said posts.

5. The crutch as claimed in claim 4 further comprising means for adjusting said hand grip relative to said posts.

6. The crutch as claimed in claim 5, wherein said adjusting means includes a pair of plates secured to said posts respectively, and a fastener adjustably securing said hand grip between said plates.

7. The crutch as claimed in claim 6, wherein said plates each includes a groove formed therein, said hand grip includes a bore formed therein, said fastener is engaged through said grooves of said plate and said bore of said hand grip, and a lock nut is threaded with said fastener to secure said hand grip to said plates.

8. The crutch as claimed in claim 6, wherein said hand grip includes two ends each having a channel formed therein, to slidably receive said plates respectively, and to guide said hand grip to move relative to said plates and said posts.

9. The crutch as claimed in claim 6 further comprising two blocks, said fastener is threaded through said blocks and engaged with said blocks to force said blocks to engage with said plates respectively.

10. The crutch as claimed in claim 9, wherein said plates each includes a plurality of teeth provided thereon, said blocks each includes a plurality of teeth provided thereon and engaged with said teeth of said plates, to secure said blocks to said plates respectively.

11. The crutch as claimed in claim 9, wherein said posts each includes a notch formed therein, to receive said blocks therein respectively.

12. The crutch as claimed in claim 1, wherein said lower portion of said crutch includes a tube, and a leg adjustably secured to said tube.

13. The crutch as claimed in claim 12 further comprising a duct secured between said tube and said leg.

14. The crutch as claimed in claim 13, wherein said duct includes a portion secured to said tube, and an inner thread formed therein, said leg includes an outer thread to thread with said inner thread of said duct.

15. The crutch as claimed in claim 13, wherein said duct includes a quick release clamp to releasably secure said leg to said duct.
